(19) United States
(12) Patent Application Publication
(10) Pub. No.: US 2025/0282243 A1
(43) Pub. Date: Sep. 11, 2025

(54) Emergency Charging System for EV Batteries

(71) Applicant: John Cappello, Lantana, TX (US)

(72) Inventor: John Cappello, Lantana, TX (US)

(21) Appl. No.: 18/901,566

(22) Filed: Sep. 30, 2024

Related U.S. Application Data
(60) Provisional application No. 63/563,586, filed on Mar. 11, 2024.

(51) Int. Cl. B60L 53/57; B60L 53/51; B60L 53/56

(52) U.S. Cl. CPC B60L 53/57; B60L 53/51; B60L 53/56

(57) ABSTRACT

An electric vehicle (EV) battery emergency charging system is disclosed. The system comprises a sealed housing containing a rechargeable battery pack, an EV battery charging port, USB ports, a hand crank, and a digital display. The system is adapted to be recharged using traditional electric supplies or through a foldable and detachable solar panel. The hand crank can be used to generate electrical energy, transformed by a magneto, to recharge the internal battery pack. The generated power can be used to recharge the EV battery or power other appliances via USB ports. A battery management system provides safe charging and discharge cycles rechargeable battery pack. The system offers a reliable solution for emergency EV charging in emergency situations without reliance on charging stations.

### CROSS-REFERENCE TO RELATED APPLICATION

The present application claims priority to, and the benefit of, U.S. Provisional Application No. 63/563,586, which was filed on Mar. 11, 2024, and is incorporated herein by reference in its entirety.

### FIELD OF THE INVENTION

The present invention generally relates to the field of electric vehicles. More specifically, the present invention relates to a novel emergency charging solution for electric vehicles. The solution is in the form of a portable system that can be an add-on feature for new EVs or as a standalone portable unit. The system includes a battery that can be charged using traditional sources of energy or using a hand crank which is attached to the system. Accordingly, the present disclosure makes specific reference thereto. Nonetheless, it is to be appreciated that aspects of the present invention are also equally applicable to other like applications, devices, and methods of manufacture.

### BACKGROUND

By way of background, electric vehicles (EVs) have become popular as they are eco-friendly, significantly reducing or even eliminating emissions of pollutants and greenhouse gases. EVs also reduce the world's reliance on gasoline and fossil fuels. EVs also have lower operating costs compared to traditional vehicles powered by internal combustion engines. Charging an EV is often more economical than filling up a gas tank, and there are fewer maintenance and repair expenses.

However, battery packs of EVs have limited power levels which can run the EV for a limited range. The availability of charging infrastructure can also be a significant hurdle. Many areas, especially along major roadways, may lack sufficient EV charging stations, making long-distance travel in an EV more challenging. As a result, EV owners are concerned about running out of battery power at inconvenient times, potentially leaving them stranded. This concern can lead to individuals traveling only short distances with their electric vehicles. Additionally, potential power outages can cause recharging issues, and if individuals cannot locate a charging station while on the road, they may not be able to continue their journey. Currently, there is no existing device which can be used to recharge EVs in emergency situations without dependence on solar energy and charging stations.

Therefore, there exists a long-felt need in the art for an emergency charging system for electric vehicles. There is also a long-felt need in the art for an innovative emergency charging solution for EVs that can provide supplemental charge for EV batteries. Additionally, there is a long-felt need in the art for a special device that can be used as an emergency charging solution for EVs and can be an add-on feature for new EVs or as a standalone portable unit. Moreover, there is a long-felt need in the art for a uniquely designed device that has an attachable or hidden hand crank for generating electricity to provide EV batteries. Further, there is a long-felt need in the art for a device that has a hand crank for manual power generation, especially in emergencies where no other power sources are available. Finally, there is a long-felt need in the art for a uniquely designed portable generator device that eliminates the need to depend on solar energy to charge devices or stop at charging stations to charge electric vehicles.

The subject matter disclosed and claimed herein, in one embodiment thereof, comprises an emergency charging system for EV batteries and other electrical devices. The system comprises an IP 67 housing having a front panel, a rear panel, a pair of side panels, a top wall, and a bottom wall. An EV battery charging port is disposed on one of the side panels for receiving an EV battery charging cord and one or more USB ports for providing or enabling electrical supply to the other electrical devices. A rechargeable battery pack is included within the housing for storing electrical energy. A hand crank is disposed on a side wall of the housing for manually generating electrical energy. A magneto is configured to transform mechanical energy produced by the hand crank into electrical energy to recharge the battery pack. The hand crank, when rotated, activates the system, thereby enabling the flow of electric power from the EV battery charging port to recharge an EV battery and one or more USB ports to recharge connected other electrical devices.

In this manner, the emergency charging system for EV batteries and other electrical devices of the present invention accomplishes all of the foregoing objectives and provides users with a novel device to recharge EV batteries and other connected devices in emergency situations. The system is designed to be lightweight and portable, making it easy to store in the trunk of an EV or carry as needed. The system can be recharged using traditional electric supplies before a trip, providing a reliable source of backup power. Additionally, the hand crank enables for manual power generation in emergencies, ensuring the user can generate power even in the absence of traditional power sources. The system addresses the common concerns of EV owners about running out of battery power at inconvenient times. The system also helps in providing longer trips and reducing dependency on charging stations.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an electric vehicle battery emergency charging system. The system comprises a sealed housing having a front panel, a rear panel, a pair of side panels, a top wall, and a bottom wall. An EV battery charging port is disposed on one of the side panels for receiving an EV battery charging cord. A rechargeable battery pack is included within the housing for storing electrical energy. A hand crank is disposed on a side wall of the housing for manually generating electrical energy. A magneto is configured to transform mechanical energy produced by the hand crank into electrical energy to recharge the battery pack. The hand crank, when rotated, activates the system, thereby enabling the flow of electric power from the EV battery charging port to recharge an EV battery.

In yet another embodiment, the hand crank is disposed on a side wall of a sealed housing, a magneto is coupled to the hand crank and is configured to transform mechanical energy into electrical energy, wherein the hand crank, when rotated, generates electricity, and enables the flow of electric power from one or more ports disposed on the housing.

In another embodiment, the system includes a battery management system coupled to the rechargeable battery pack and is configured to manage charge and discharge cycles of the battery pack. A digital display is disposed on the front panel for displaying electric charge value and remaining battery percentage of the battery pack. A physical or digital lock is disposed on one of the side panels for providing or enabling authorized access to the internal components of the system.

In another aspect, the device includes a foldable and detachable solar panel for absorbing solar energy and converting it into electrical energy to recharge the battery pack.

In yet another aspect, a method of recharging an electric vehicle (EV) battery using an emergency charging system is described. The method includes the steps of providing an emergency charging system having a sealed housing with a rechargeable battery pack, an EV battery charging port, a hand crank, a magneto, and a battery management system, connecting the EV battery charging port of the emergency charging system to the EV battery via an EV battery charging cord, rotating the hand crank to generate mechanical energy, transforming the mechanical energy into electrical energy using the magneto, directing the generated electrical energy to recharge the rechargeable battery pack, and managing the charge and discharge cycles of the rechargeable battery pack using the battery management system to ensure safe and efficient operation. The method also includes recharging the rechargeable battery pack of the emergency charging system using a traditional electric supply prior to an emergency.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of electric vehicle battery emergency charging system of the present invention in accordance with the disclosed structure;

FIG. 2 illustrates a side block diagram view of the electric vehicle battery emergency charging system showing internal components of the system in accordance with one embodiment of the present invention;

FIG. 3 illustrates a perspective view showing the EV battery charging device of the present invention connected to the battery of an EV in accordance with the disclosed structure; and

FIG. 4 illustrates a top view of another embodiment of the EV power generator of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a exists a long-felt need in the art for an emergency charging system for electric vehicles. There is also a long-felt need in the art for an innovative emergency charging solution for EVs that can provide supplemental charge for EV batteries. Additionally, there is a long-felt need in the art for a special device that can be used as an emergency charging solution for EVs and can be an add-on feature for new EVs or as a standalone portable unit. Moreover, there is a long-felt need in the art for a uniquely designed device that has an attachable or hidden hand crank for generating electricity to provide EV batteries. Further, there is a long-felt need in the art for a device that has a hand crank for manual power generation, especially in emergencies where no other power sources are available. Finally, there is a long-felt need in the art for a uniquely designed portable generator device that eliminates the need to depend on solar energy to charge devices or stop at charging stations to charge electric vehicles.

The present invention, in one exemplary embodiment, is a method of recharging an EV battery using an emergency charging system. The method includes the steps of providing an emergency charging system having a sealed housing with a rechargeable battery pack, an EV battery charging port, a hand crank, a magneto, and a battery management system. The method also includes connecting the EV battery charging port of the emergency charging system to the EV battery via an EV battery charging cord, rotating the hand crank to generate mechanical energy, and directing electrical energy to recharge the rechargeable battery pack. The method also includes recharging the rechargeable battery pack of the emergency charging system using a traditional electric supply prior to an emergency.

Reference will now be made in detail to the present preferred embodiments of the invention, examples of which are illustrated in the accompanying drawings. Wherever possible, the same reference numerals are used in the drawings and the description to refer to the same or like parts.

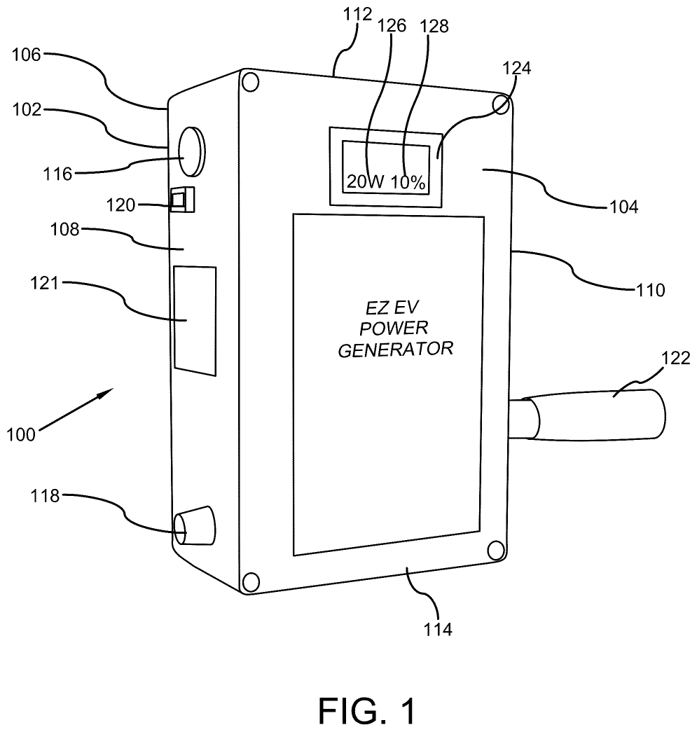

Referring initially to the drawings, FIG. 1 illustrates a perspective view of electric vehicle battery emergency charging system of the present invention in accordance with the disclosed structure. The electric vehicle battery emergency charging system or generator 100 of the present invention is designed as an emergency charging solution for electric vehicles (EVs). The emergency charging system 100 is in the form of a generator that includes a sealed housing 102 having a front panel 104, a rear panel 106, a pair of side panels 108, 110, a top wall 112, and a bottom wall 114. The housing 102 is adapted to store the circuitry and other electric elements of the emergency charging system or generator 100 for providing or enabling electric power to the battery of an EV or any other appliance when connected to the system 100.

More specifically, the side panel 108 includes a physical or digital lock 116 for providing or enabling authorized access to opening the front panel 104 to access the electric components (i.e., circuitry) stored inside the system 100. An EV battery charging port 118 is disposed on one of the side panels 108, 110 for receiving and accommodating an EV battery charging cord to provide electric power stored inside the system 100. One or more USB ports or other charging ports 120, a standard plug 121 are disposed in the side wall 108 for providing or enabling electric power to other conventional electric appliances such as an emergency light, a lamp, and more.

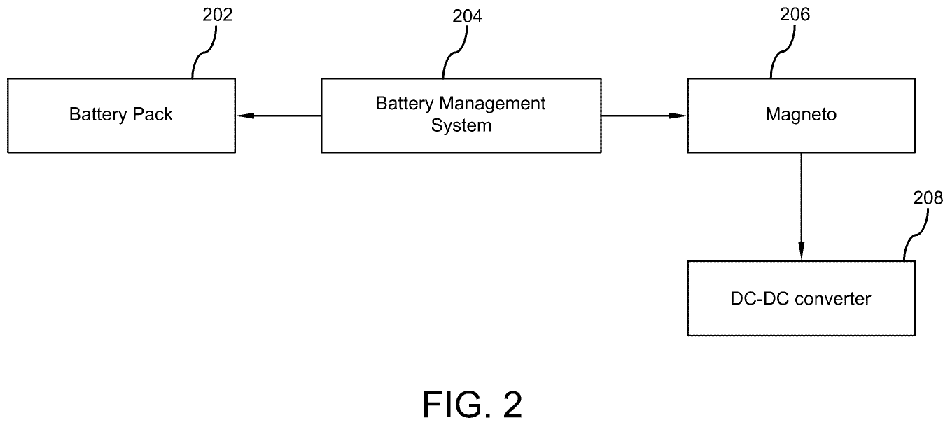

A hand crank 122 is disposed on the side wall 110 of the housing. The hand crank 122 provides the mechanical energy to turn a magneto (FIG. 2) to produce electricity. The hand crank 122 can be used to crank the generator device 100 for generating electricity. The hand crank 122 when rotated activates the system 100, thereby generating electricity and enabling flow of electric power from one or more ports 118, 120.

The front panel 104 includes a digital display 124 disposed thereon. The digital display 124 is adapted to display the electric charge value 126 and remaining battery percentage 128 of the system 100. The display 124 provides real time electric charge information of the system 100 and can also illuminate in a first color such as GREEN when the system 100 is activated and may illuminate in a second color such as RED when the system 100 malfunctions.

The EV battery emergency charging system or generator 100 is portable and lightweight. Further, the emergency charging system or generator 100 can be stored in the trunk of a vehicle or at home. The EV battery emergency charging system or generator 100 can be designed as an add-on feature for new EVs or as a standalone portable unit. In use, users can charge the emergency generator device 100 using traditional power sources before beginning a trip and in the event of an emergency such as where the EV's battery is depleted and no other charging sources are available, the hand crank can be used to generate power manually. Preferably, the system 100 functions in a temperature range from about −30 degrees Celsius to about 55 degrees Celsius. The housing 102 has an IP67 rating and can work in any weather.

FIG. 2 illustrates a block diagram view of the electric vehicle battery emergency charging system or generator 100 showing internal components of the system in accordance with one embodiment of the present invention. As illustrated, the system 100 includes a rechargeable battery pack 202 which can be in the form of Lithium-ion or another high-capacity battery pack to store electrical energy therein. The rechargeable battery pack 202 stores electrical energy which is provided to EV batteries and other appliances in case of an emergency. The rechargeable battery pack 202 is coupled to a battery management system 204 which is configured to manage the charge and discharge cycles of the battery pack 202, thereby providing safety and efficiency. The battery management system 204 prevents overcharging and overheating of the battery pack 202 and can provide an automatic disconnection to prevent recharging of the battery pack 202.

A magneto 206 is included in the system 100 for transforming the mechanical energy produced by turning the hand crank 122 into electrical energy. The electrical energy is adapted to recharge the internal battery pack 202 of the EV power generator 100. The internal battery pack 202 can also be recharged using a traditional electric supply, such as a household AC outlet. A DC-DC converter 208 is included in the system 100 to step up or step down the DC voltage as required by the connected EV battery and other appliances. In the preferred embodiment, the battery management system 204 automatically configures an electrical energy discharge rate from the battery pack 202 based on the connected EV battery to the EV battery charging port 118. In some embodiments, a portion of the energy of the battery pack 202 can be used for automatically operating the hand crank 122 for generating electricity.

It will be apparent to a person skilled in the art that the battery pack 202 is swappable and can be easily replaced. Further, additional ports such as for electric appliances like television and dashboard of a vehicle can be added to the housing 102. Different sensors to monitor temperature, voltage, and current can be included in the system 100 to enable safe operation of the EV power generator 100.

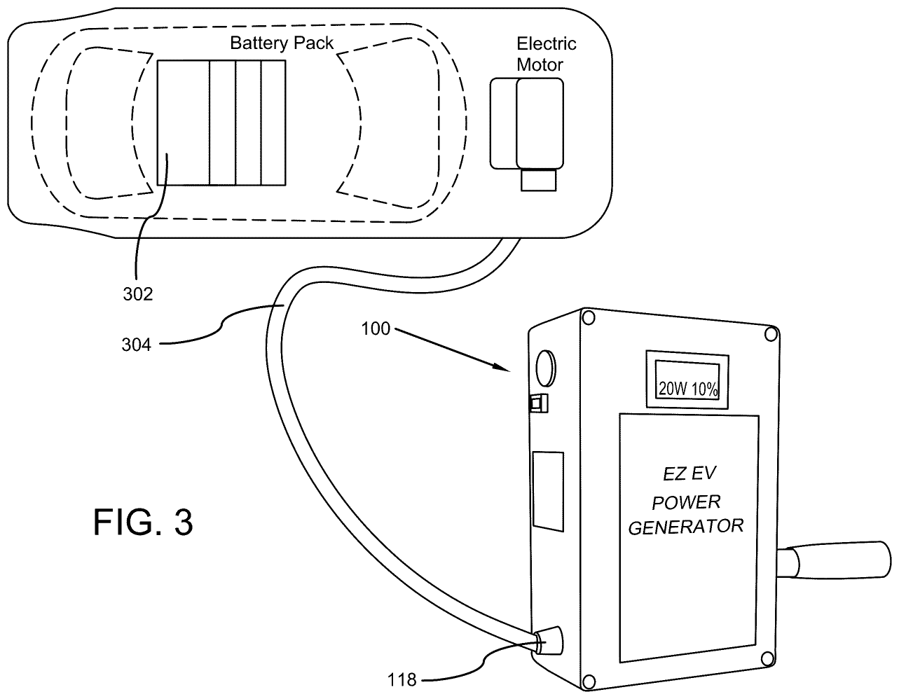

FIG. 3 illustrates a perspective view showing the EV battery charging device of the present invention connected to the battery of an EV in accordance with the disclosed structure. As illustrated, the port 118 of the generator device 100 is connected to the EV battery 302 via the EV battery charging cord 304. The EV battery 302 is automatically charged using the electrical energy stored in the battery pack 202 of the generator device 100. Furthermore, the hand crank 122 can be manually operated to generate electrical power in the battery pack 202. The hand crank 122 is useful in emergencies where no other power sources are available and enables for the recharging of the internal battery and provides an immediate power supply to connected devices.

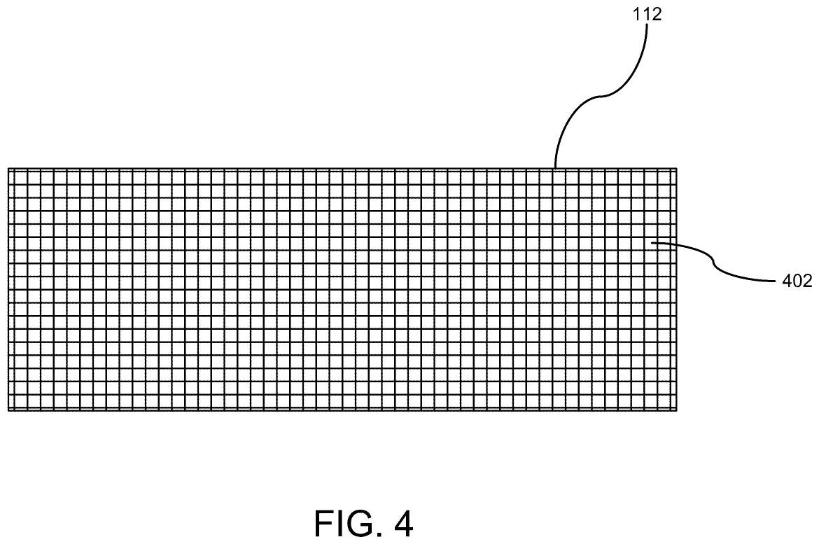

FIG. 4 illustrates a top view of another embodiment of the EV power generator of the present invention in accordance with the disclosed structure. In the present embodiment, the generator device 100 includes a foldable and detachable solar panel 402 disposed on the top wall 112 for absorbing solar energy and converting it into electrical energy. The converted electrical energy is stored in the battery pack 202 of the system 100 for providing or enabling recharging to an EV battery.

It will be apparent to a person skilled in the art that in scenarios where traditional power sources (such as electrical outlets or solar power) are unavailable, the hand crank 122 provides a reliable means of generating power manually and enables a user to generate electrical power to get the vehicle moving again. Power generation by hand crank 122 does not rely on fossil fuels or electricity, making it an environmentally friendly option.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “electric vehicle battery emergency charging system”, “emergency charging system”, “EV power generator”, “generator device”, and “system” are interchangeable and refer to the electric vehicle battery emergency charging system or generator 100 of the present invention.

Notwithstanding the foregoing, the electric vehicle battery emergency charging system or generator 100 of the present invention can be of any suitable size and configuration as is known in the art without affecting the overall concept of the invention, provided that it accomplishes the above-stated objectives. One of ordinary skill in the art will appreciate that the electric vehicle battery emergency charging system or generator 100 as shown in the FIGS. are for illustrative purposes only, and that many other sizes and shapes of the electric vehicle battery emergency charging system or generator 100 are well within the scope of the present disclosure. Although the dimensions of the electric vehicle battery emergency charging system or generator 100 are important design parameters for user convenience, the electric vehicle battery emergency charging system or generator 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A portable electric vehicle battery emergency charging system comprising:
a portable generator having a housing including a front panel, a rear panel, a pair of side panels, a top wall, and a bottom wall;
a hand crank;
a circuitry;
a rechargeable battery pack;
an EV battery charging port;
an EV battery charging cord;
a USB port; and
a plug;
wherein said circuitry enclosed by said housing;
wherein at least one of said pair of side panels having a digital lock for enabling access to opening said front panel to access said circuitry;
wherein said EV battery charging port receives said EV battery charging cord to provide electric power stored inside said generator;
wherein at least one of said USB port and said plug for providing electric power to an electric appliance;
wherein said hand crank rotatable for turning a magneto to convert mechanical energy into electrical energy; and
further wherein said electricity supplied to said USB port and said plug.

2. The portable electric vehicle battery emergency charging system of claim 1, wherein said front panel having a digital display for displaying an electric charge value and remaining battery percentage of the emergency charging system.

3. The portable electric vehicle battery emergency charging system of claim 2, wherein said electric appliance is selected from the group consisting of an emergency light and a lamp.

4. The portable electric vehicle battery emergency charging system of claim 2, wherein said rechargeable battery pack is a Lithium-ion battery pack.

5. The portable electric vehicle battery emergency charging system of claim 4, further comprising a battery management system for managing a charge cycle and a discharge cycle of said rechargeable battery pack.

6. The portable electric vehicle battery emergency charging system of claim 5, wherein said battery management system prohibiting overcharging of said rechargeable battery pack.

7. The electric vehicle battery emergency charging system of claim 6 further comprising a DC-DC converter for receiving power from an AC outlet to charge said rechargeable battery pack.

8. The electric vehicle battery emergency charging system of claim 7, wherein said battery management system having a controlled electrical energy discharge rate from said rechargeable battery pack based on a connected EV battery to said EV battery charging port.

9. The electric vehicle battery emergency charging system of claim 8, wherein said battery management system automatically charging said connected EV battery when said EV battery charging cord is connected between said portable generator and said connected EV battery.

10. The electric vehicle battery emergency charging system of claim 7, wherein said hand crank is manually rotatable.

11. The electric vehicle battery emergency charging system of claim 10, wherein said portable generator having a solar panel mounted to said top wall for absorbing solar energy and converting the solar energy into electrical energy.

12. A portable electric vehicle battery emergency charging system comprising:
a portable generator having a housing including a front panel, a rear panel, a pair of side panels, a top wall, and a bottom wall;
a hand crank;
a circuitry;
a rechargeable battery pack;
an EV battery charging port;
an EV battery charging cord;
a USB port;
a DC-DC converter; and
a plug;
wherein said circuitry enclosed by said housing;
wherein said EV battery charging port receives said EV battery charging cord to provide electric power stored inside said generator;
wherein at least one of said USB port and said plug for providing electric power to an electric appliance;
wherein said hand crank manually rotatable for turning a magneto to convert mechanical energy into electrical energy;
wherein said electricity supplied to said USB port and said plug; and
further wherein said DC-DC converter for receiving power from an AC outlet to charge said rechargeable battery pack.

13. The portable electric vehicle battery emergency charging system of claim 12, wherein said front panel having a digital display for displaying an electric charge value and remaining battery percentage of the emergency charging system.

14. The portable electric vehicle battery emergency charging system of claim 12, wherein said electric appliance is selected from the group consisting of an emergency light and a lamp.

15. The portable electric vehicle battery emergency charging system of claim 12, wherein said rechargeable battery pack is a Lithium-ion battery pack.

16. The portable electric vehicle battery emergency charging system of claim 12, further comprising a battery management system for managing a charge cycle and a discharge cycle of said rechargeable battery pack.

17. The portable electric vehicle battery emergency charging system of claim 16, wherein said battery management system prohibiting overcharging of said rechargeable battery pack.

18. The electric vehicle battery emergency charging system of claim 17, wherein said battery management system having a controlled electrical energy discharge rate from said rechargeable battery pack based on a connected EV battery to said EV battery charging port.

19. The electric vehicle battery emergency charging system of claim 18, wherein said battery management system automatically charging said connected EV battery when said EV battery charging cord is connected between said portable generator and said connected EV battery.

20. A portable electric vehicle battery emergency charging system comprising:
a portable generator having a housing including a front panel, a rear panel, a pair of side panels, a top wall, and a bottom wall;
a hand crank;
a circuitry;
a rechargeable battery pack;
an EV battery charging port;
an EV battery charging cord;
a USB port;
a DC-DC converter;
a solar panel; and
a plug;
wherein said circuitry enclosed by said housing;
wherein said EV battery charging port receives said EV battery charging cord to provide electric power stored inside said generator;
wherein at least one of said USB port and said plug for providing electric power to an electric appliance;
wherein said hand crank manually rotatable for turning a magneto to convert mechanical energy into electrical energy;
wherein said electricity supplied to said USB port and said plug;
wherein said DC-DC converter for receiving power from an AC outlet to charge said rechargeable battery pack; and
further wherein said solar panel mounted to said top wall for absorbing solar energy and converting the solar energy into electrical energy.
